(19) United States
(12) Patent Application Publication
(10) Pub. No.: US 2025/0117633 A1
(43) Pub. Date: Apr. 10, 2025

(54) UNCERTAINTY QUANTIFICATION FOR GENERATIVE ARTIFICIAL INTELLIGENCE MODEL

(71) Applicant: Intel Corporation, Santa Clara, CA (US)

(72) Inventors: Anthony Daniel Rhodes, Portland, OR (US); Ramesh Radhakrishna Manuvinakurike, Hillsboro, OR (US); Sovan Biswas, Bonn (DE); Giuseppe Raffa, Portland, OR (US); Lama Nachman, Santa Clara, CA (US)

(73) Assignee: Intel Corporation, Santa Clara, CA (US)

(21) Appl. No.: 18/987,302

(22) Filed: Dec. 19, 2024

(51) Int. Cl. G06N 3/0475

(52) U.S. Cl. CPC G06N 3/0475

(57) ABSTRACT

Predictive uncertainty of a generative machine learning model may be estimated. The generative machine learning model may be a large language model or large multi-modal model. A datum may be input into the generative machine learning model. The generative machine learning model may generate outputs from the datum. Latent embeddings for the outputs may be extracted from the generative machine learning model. A covariance matrix with respect to the latent embeddings may be computed. The covariance matrix may be a two-dimensional matrix, such as a square matrix. The predictive uncertainty of the generative machine learning model may be estimated using the covariance matrix. For instance, the matrix entropy of the covariance matrix may be determined. The matrix entropy may be an approximated dimension of a latent semantic manifold spanned by the outputs of the generative machine learning model and may indicate the predictive uncertainty of the generative machine learning model.

### TECHNICAL FIELD

This disclosure relates generally to neural network (also referred to as “deep neural network” or “DNN”), and more specifically, uncertainty quantification for DNNs, including generative artificial intelligence (AI) models.

### BACKGROUND

DNNs are used extensively for a variety of AI applications ranging from computer vision to speech recognition and natural language processing due to their ability to achieve high accuracy. However, DNNs sometimes make unexpected, incorrect, but overconfident predictions. This can cause serious consequences in high-stake applications, such as autonomous driving, medical diagnosis, disaster response, and so on. Uncertainty quantification typically aims to estimate the certainty or confidence of DNN predictions beyond prediction accuracy.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an uncertainty quantification system, in accordance with various embodiments.

FIG. 2 illustrates generative-semantic entropy estimation for a generative model, in accordance with various embodiments.

FIG. 3 illustrates a non-isotropic semantic manifold, in accordance with various embodiments.

FIG. 4 illustrates an isotropic semantic manifold, in accordance with various embodiments.

FIG. 5A illustrates an example transformer model, in accordance with various embodiments.

FIG. 5B illustrates an embedding operation in an embedding layer, in accordance with various embodiments.

FIG. 5C illustrates an embedding operation in another embedding layer, in accordance with various embodiments.

FIG. 6 illustrates a first inference phase of a transformer model, in accordance with various embodiments.

FIG. 7 illustrates subsequent inference phases of the transformer model, in accordance with various embodiments.

FIG. 8 is a flowchart of a method of uncertainty quantification for a generative model, in accordance with various embodiments.

FIG. 9 is a block diagram of an example computing device, in accordance with various embodiments.

### DETAILED DESCRIPTION

### Overview

The last decade has witnessed a rapid rise in AI based data processing, particularly based on DNNs. DNNs are widely used in the domains of computer vision, language processing, speech recognition, image, and video processing mainly due to their ability to achieve beyond human-level accuracy. A DNN typically includes a sequence of layers. A DNN layer may include one or more deep learning operations (also referred to as “neural network operations”), such as convolution, matrix multiplication, layer normalization, batch normalization, SoftMax operation, pooling, elementwise operation, linear operation, nonlinear operation, and so on.

Input or output data of deep learning operations may be arranged in data structures called tensors. A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors.

AI is identified with powerful multifunctional foundation models, including Large Language Models (LLMs) and Large Multi-Modal Models (LMMs). Large foundational models, including Chat-GPT, Llama, Llava, and many more, represent a revolution in AI—ushering in a new era of multi-faceted, intelligent conversational agents bearing the potential to transform a large number of business and operational efficiencies across many diverse use cases, including medical diagnostics, personal assistants, content creation, and so on. However, many foundational models suffer from hallucination, which can severely limit their trustworthiness and general use, particularly for human-in-the-loop (HiTL) applications. The widespread adoption and future success of LLMs and related models can be critically dependent upon efforts to improve their transparency and explainability.

Many currently available uncertainty quantification solutions leverage a separate Natural Language Inference (NLI) model to compare the pairwise semantic similarity of LLM-generated responses or some other NLI-related measure, including entailment, with computational complexity O(n²), where n denotes the number of neural language generations (NLGs). Such solutions suffer from drawbacks. For instance, they typically require additional model compute/inference to approximate semantic similarity. This extra compute can be unwieldy and can hinder real-time performance. Also, the semantic similarity measure typically relies on extrinsic uncertainty estimates, independent of the LLM itself, thus adding undesirable noise to the uncertainty quantification estimation process. Some other solutions simply calculate the “EigenScore” over generated LLM outputs, which yields an approximate average eigenvalue with respect to the principal components over the sample data.

Embodiments of the present disclosure may improve on at least some of the challenges and issues described above by using generative-semantic entropy estimation for uncertainty quantification for generative outputs of AI models. In an example of the generative-semantic entropy estimation method, multiple outputs (e.g., language outputs) may be generated by a generative AI model from an input datum and the semantic diversity (e.g., semantic diversity with respect to the model latent space) of a low-dimensional manifold encapsulating the generated outputs may be approximated. A large semantic diversity may indicate a high model uncertainty. Generative-semantic entropy estimation can function as a lightweight, model-agnostic algorithm method to estimate uncertainty quantification for generative models. It can be performant in a variety of essential settings, including unbounded language prompting, constrained language prompting, high/low generative stochasticity, acutely diverse semantic situations, and so on.

In various embodiments of the present disclosure, predictive uncertainty of a generative AI model may be estimated. The generative AI model may also be referred to as a generative machine learning model. The generative machine learning model may be a transformer-based model, such as an LLM or LMM. A datum may be input into the generative machine learning model. The generative machine learning model may generate multiple outputs from the datum.

Latent embeddings for the outputs may be extracted from the generative machine learning model. A latent embedding for an output may be associated with one or more token likelihoods of the output. A token likelihood may be the likelihood of the generative machine learning model selecting a token for the output. In an example, the latent embedding may be the average of a plurality of token likelihoods of the output. In another example, the latent embedding may be the largest or smallest token likelihood of the output. A covariance matrix with respect to the latent embeddings may be computed. For instance, the latent embeddings may be centered, e.g., by mean subtracting. The length-normalized covariance of the centered embeddings may be determined. The length-normalized covariance may be the covariance matrix. The covariance matrix may be a two-dimensional matrix, such as a square matrix. The matrix entropy of the covariance matrix may be determined. The matrix entropy may indicate the predictive uncertainty of the generative machine learning model.

Taking a LLM for example, generative-semantic entropy estimation can provide uncertainty quantification for the generative output of the model through a series of steps: (1) generate multiple outputs from an input datum using the stochasticity of the LLM model, gauged by the LLM “temperature” parameter; (2) extract latent embeddings for each of these generated outputs; (3) calculate the covariance matrix with respect to these latent semantic embedding; (4) define the uncertainty quantification as the matrix entropy of this covariance matrix. The matrix entropy may approximate an effective dimension of a semantic manifold spanned by the generative outputs. Larger entropy may correspond with larger semantic diversity in the generated outputs, and thus higher model uncertainty.

This disclosure provides a computationally efficient and generalizable method to estimate the generative uncertainty of AI models, including LLMs and related models. This method may require no additional inference models. Also, it can be applied across any LLM or LMM architecture. For various types of input data (e.g., text prompt, image, video, audio, or some combination thereof), the generative-semantic entropy estimation approach can numerically estimate the uncertainty encapsulated in the semantic manifold of the DNN generated responses to the input data. High uncertainty may be indicative of hallucinations and low generative confidence. The generative-semantic entropy estimation approach can help facilitate better DNN performance, enhance DNN-related human interaction, foster trust in foundational model dependent systems, understand cross-modal, LMM uncertainty (e.g., visual vs linguistic uncertainty), and make RAG (Retrieval Augmented Generation) and related enabled DNNs more effective, and so on.

Instead of simply calculating the “EigenScore” over generated LLM outputs, the approach in this disclosure is with respect to the latent semantic manifold (e.g., the semantic features in the sample data). Furthermore, because generative-semantic entropy estimation may be calculated from matrix entropy, the measure of uncertainty can account for the (comparatively richer) entire distribution of the semantic manifold and not simply the average eigenvalue over the NLG samples.

At a high level, improving uncertainty quantification for LLMs and related models can greatly expand their usefulness and applicability, particularly in safety-critical applications and HiTL workflows, e.g., “AI PC” and manufacturing tasks. Reliable and trusted LLM performance can be a critical element to help spur future market growth. In terms of core algorithm advantages, generative-semantic entropy estimation may not require additional NLI or related processing steps (as required by other LLM uncertainty quantification methods)—boosting its relevance for real-time and computationally-constrained environments. Generative-semantic entropy estimation is moreover model-agnostic and can outperform other baseline uncertainty quantification techniques on challenging multi-modal Q/A datasets.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

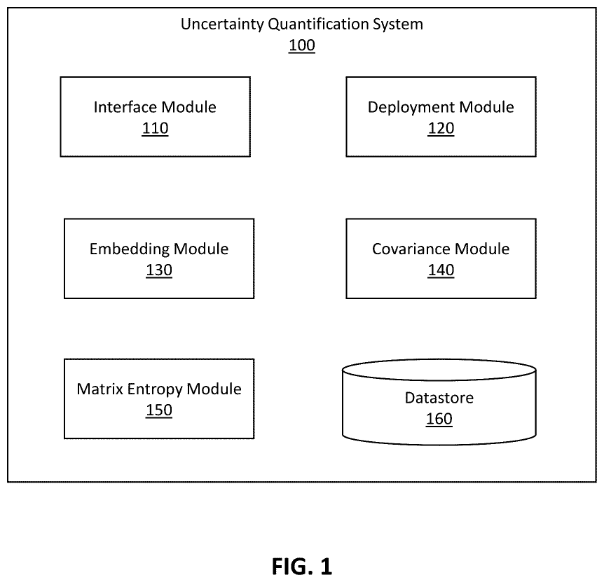

FIG. 1 is a block diagram of an uncertainty quantification system 100, in accordance with various embodiments. The uncertainty quantification system 100 can approximate predictive uncertainties of DNNs, including transformer-based models, such as LLMs, LMMs, and so on. The approximated predictive uncertainties may be used for hallucination detection, improved generative performance, and so on. As shown in FIG. 1, the uncertainty quantification system 100 includes an interface module 110, a deployment module 120, an embedding module 130, a covariance module 140, a matrix entropy module 150, and a datastore 160. In other embodiments, alternative configurations, different or additional components may be included in the uncertainty quantification system 100. Further, functionality attributed to a component of the uncertainty quantification system 100 may be accomplished by a different component included in the uncertainty quantification system 100 or a different module or system.

The interface module 110 facilitates communications of the uncertainty quantification system 100 with other modules or systems. In some embodiments, the interface module 110 may receive DNNs from one or more other systems or devices. In an example, a DNN received by the interface module 110 may be an LLM, which may be specialized in processing and generating textual data. The LLM may be trained primarily on large corpora of text and may be adept at understanding and generating human language in a variety of contexts. In another example, a DNN received by the interface module 110 may be an LMM, which may be designed to understand and process multiple types of data inputs or modalities, such as text, images, audio, video, other types of data, or some combination thereof. The LMM may integrate and make sense of these different data types simultaneously.

In other embodiments, the interface module 110 may establish communications between the uncertainty quantification system 100 with an external database to receive data or information from which DNNs can be generated. For instance, the interface module 110 may receive data or information to be used to design the architecture of a DNN, such as layers in the DNN. The interface module 110 may also receive data that can be used to train or deploy DNNs for uncertainty quantification or for performing AI tasks.

The deployment module 120 may deploy DNNs for uncertainty quantification or for performing AI tasks. In some embodiments, the deployment module 120 may obtain (e.g., receive, select, generate, etc.) a datum to be input into a DNN. The datum may also be referred to as an input datum. The input datum may include one or more types of data, such as text, image, audio, video, and so on. In some embodiments, the deployment module 120 may obtain the input datum based on the DNN. In an example where the DNN is an LLM, the deployment module 120 may use a text prompt as the input datum. In another example where the DNN is an LMM, the deployment module 120 may use a combination of text and image as the input datum. After the deployment module 120 inputs the input datum into the DNN, the input datum may be processed in one or more layers of the DNN.

In some embodiments, the deployment module 120 may provide the input datum into a neural processing unit (NPU). The NPU may execute DNNs. For instance, the NPU may carry out neural network operations in the DNN. The process of carrying out a neural network operation is also referred to as a process of executing the neural network operation or performing the neural network operation. The NPU may be a DNN accelerator. In some embodiments, the NPU includes a memory, one or more data processing units, and a direct memory access engine that may transfer data between the memory and the one or more data processing units. A data processing unit may include processing elements, which may be arranged in an array. A processing element may include one or more multiplier and one or more adders. The processing elements can perform multiply-accumulate (MAC) operations. The data processing unit may also include acceleration logic, which may acceleration neural network operations based on data sparsity. For instance, the acceleration logic can acceleration computations based on sparsity in input activation tensors or weight tensors. In some embodiments, the NPU may operate in accordance with instructions (e.g., configuration parameters) provided by a compiler that generates an executable DNN from information of the DNN.

The input datum from the deployment module 120 may be written into the memory of the NPU, then transferred to one or more data processing units by the direct memory access engine. The NPU may run an inference process of the DNN for uncertainty quantification. During the inference process, the one or more data processing units may execute neural network operations (e.g., convolutions, etc.) in the DNN with the input datum or new data generated from the input datums. In some embodiments, the DNN may be executed by one or more central processing units, graphics processing units, or other types of processing units in addition to or alternative to the NPU.

The deployment module 120 may obtain one or more generative outputs of the DNN. In some embodiments, the DNN may have multiple outputs. In some embodiments, the DNN may be a generative model that is modulated vias its temperature parameter(s). Utilizing the stochasticity of the generative mode, a set of outputs may be generated. A generative output of the DNN may be textual, visual, or auditory. In some embodiments, the outputs may be generative language outputs. In some embodiments, an output may include one or more data types, such as text, image, video, audio, other types of data types, or some combination thereof. In some embodiments, the generative outputs of the DNN may be generated through multiple inference phases of the DNN.

The embedding module 130 extracts latent embeddings from the DNN for the generative outputs of the DNN. The embedding module 130 may extract the latent embeddings from the DNN based on token likelihoods associated with the generative outputs. In some embodiments, a generative output of the DNN may include one or more tokens. For instance, the DNN may generate multiple tokens in an inference phase and select one or more of these tokens as a generative output. The DNN may determine a token likelihood for each token. The token likelihood may indicate the likelihood of the DNN selecting the token as at least part of the generative output. In some embodiments, the DNN does not output token likelihoods. Token likelihoods may be extracted from the DNN as latent features.

In some embodiments, the embedding module 130 may average token likelihoods of the generative outputs to determine the latent embeddings. In an example, the embedding module 130 may average the token likelihoods associated with a generative output to determine a latent embedding for the generative output. In other embodiments, the embedding module 130 may identify the largest or smallest token likelihoods of the generative outputs as the latent embeddings. For example, the embedding module 130 may rank the token likelihoods associated with a generative output to identify the largest or smallest token likelihood and use the largest or smallest token likelihood as the latent embedding for the generative output.

The covariance module 140 generates a covariance matrix from latent embeddings extracted by the embedding module 130. In some embodiments, the covariance module 140 may center the latent embeddings. For instance, the covariance module 140 may perform mean centering on the latent embeddings. The covariance module 140 may determine a mean of the latent embeddings and subtract the mean from each of the latent embeddings to compute centered embeddings.

To generate the covariance matrix, the covariance module 140 may perform length normalization and determine length-normalized covariance of the centered embeddings. The covariance matrix may be a symmetric matrix. In some embodiments, the covariance matrix may be a square matrix that has two dimensions, such as a dimension along the X axis and a dimension along the Y axis. The lengths of the covariance matrix along the two dimensions may be the same. The length of the covariance matrix along a dimension may equal the number of data elements arranged along the dimension. For instance, the length along the X axis may be the width and equal to the total number of data element in a row, and the length along the Y axis may be the height and equal to the total number of data element in a column. A data element in the covariance matrix may be an eigenvalue.

The matrix entropy module 150 determines a matrix entropy of the covariance matrix generated by the covariance module 140. In some embodiments, the matrix entropy may be an effective subspace rank of a semantic manifold in a latent space of the DNN. The semantic manifold may encapsulate the latent embeddings extracted by the embedding module 130. The effective subspace rank of the semantic manifold may indicate a semantical diversity of the generative outputs of the DNN. The matrix entropy may be used as a measure of a predictive uncertainty of the DNN. In some embodiments, the more semantically diverse the generative outputs, the higher the predictive uncertainty.

The datastore 160 stores data received, generated, used, or otherwise associated with the uncertainty quantification system 100. For example, the datastore 160 stores data received by the interface module 110. The datastore 160 may also store data generated by the deployment module 120, embedding module 130, covariance module 140, and matrix entropy module 150. For instance, the datastore 160 may store generative outputs of DNNs, latent embeddings of DNNs, covariance matrices, predictive uncertainties of DNNs, and so on. The datastore 160 may also store information of DNNs, such as graphs representing DNNs, hyperparameters of DNNs, internal parameters of DNNs, instructions generated from compiling DNNs, and so on. The datastore 160 may include one or more memories. In the embodiment of FIG. 1, the datastore 160 is a component of the uncertainty quantification system 100. In other embodiments, the datastore 160 may be external to the uncertainty quantification system 100 and communicate with the uncertainty quantification system 100 through a network.

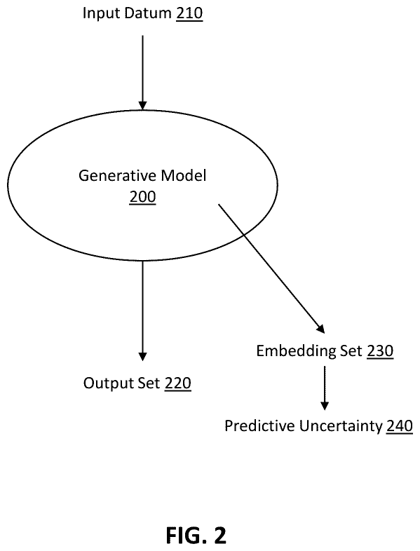

FIG. 2 illustrates generative-semantic entropy estimation for a generative model 200, in accordance with various embodiments. The generative model 200 may be an example of DNNs described above in conjunction with FIG. 1. The generative model 200 may also be referred to as a generative AI model or generative machine learning model. In some embodiments, the architecture of the generative model 200 is based on a transformer.

As shown in FIG. 2, the generative model 200 receives an input datum 210 and generates an output set 220 using the input datum 210. The input datum 210 may be an input language datum or multi-modal datum. An input language datum may include textual data and may include no other types of data. An input multi-modal datum may include multiple types of data. The output set 220 may include a plurality of generative outputs of the generative model 200. Each generative output may include one or more tokens generated by the generative model 200 from the input datum 210. A generative output may have a length which may be the total number of token(s) in the generative output. In some embodiments, the generation of the output set 220 may be denoted as LM(x)→{yⁱ}ᵢ₌₁^{i=M}, where LM denotes the generative model 200, x denotes the input datum 210, {yⁱ}ᵢ₌₁^{i=M} denotes the output set 220 including a number M generative outputs (M may be an integer), and yⁱ denotes the i-th output in the output set 220.

An embedding set 230 is extracted from the generative model 200. The embedding set 230 may include a plurality of latent embeddings, each of which my correspond to a different one of the generative outputs in the output set 220. In some embodiments, the embedding set 230 may be denoted as {zⁱ}ᵢ₌₁^{i=M}, where zⁱ denotes the i-th latent embedding in the output set 220, which corresponds to the i-th output yⁱ. In some embodiments, the embedding set 230 may be obtained by using the stochasticity of the generative model 200.

A predictive uncertainty 240 is determined from the embedding set 230. In some embodiments, the latent embeddings in the embedding set 230 are centered, e.g., through mean subtraction. A length-normalized covariance of the centered embeddings may then be computed. The predictive uncertainty 240 may correspond to a semantical diversity. Uncertainty quantification may be sensitive to output length, length normalization can address this. Length normalization in weighted covariance-based uncertainty quantification can mitigate the sensitivity of matrix entropy to output length. The covariance matrix may be denoted as

$$Cov ( z ) = \frac{1}{M} Σ \frac{1}{{p}_{i}} {z}^{i} ⊗ {z}^{i} ,$$

where Cov(z) denotes the covariance matrix (e.g., the length-normalized covariance), pᵢ denotes the length (e.g., the total number of tokens) of the i-th output yⁱ.

In some embodiments, the predictive uncertainty 240 is a matrix entropy of the covariance matrix Cov(z) and may be denoted as UQ[LM(x)]:=−tr[Cov(z)log(Cov(z))], where tr denotes the trace. The trace of a square matrix may be the sum of the data elements in the square matrix on its main diagonal. The matrix entropy may be a von Neumann entropy. In some embodiments, the matrix entropy may be computed from eigenvalues of the covariance matrix. The matrix entropy may be denoted as UQ[LM(x)]=−Σⱼ₌₁^{d}λⱼ log λⱼ, where λⱼ denotes the j-th eigenvalue of the covariance matrix, and d denote the total number of eigenvalues of the covariance matrix. In some embodiments, the eigenvalues of the covariance matrix are positive numbers having values above zero.

The covariance matrix Cov(z) may be a square, symmetric matrix of spatial size d×d. d denotes the length of the covariance matrix Cov(z) along the X or Y axis. In some embodiments, d may be a large number, such as several thousand. In some embodiments, a subset of the eigenvalues of the covariance matrix, as opposed to all the eigenvalues, is used to compute the matrix entry. To select the subset, the eigenvalues may be ranked, e.g., based on their values, and the subset may be selected based on the ranking. The matrix entropy computed from the subset may be sufficient for estimating the predictive uncertainty 240. In some embodiments, a selected eigenvalue may be larger than an unselected eigenvalue. Unselected eigenvalues may be near zero. In some embodiments, a hyperparameter k of the generative model 200 may be determined, e.g., by the matrix entropy module 150 in FIG. 1. The matrix entropy module 150 may select the top k eigenvalues of the covariance matrix and use the k eigenvalues to compute the matrix entropy. In an example, k may be 20 or near 20.

In some embodiments, the matrix entropy module 150 may determine an optimal value of k based on one or more attributes of the generative model 200 or M, which is the total number of outputs in the output set 220. In some embodiments, the matrix entropy module 150 may optimize the value of the hyperparameter k using one or more hyperparameter optimization approaches. The optimal value of the hyperparameter k may be determined together with the optional value(s) of one or more other hyperparameters of the generative model 200. Using this top-k approach, the matrix entropy module 150 may compute the matrix entropy using a truncated singular value decomposition algorithm.

In some embodiments, the matrix entropy may approximate the “information content”, which is the effective subspace rank of the semantic manifold encapsulated by the embedding set 230 {zⁱ}ᵢ₌₁^{i=M}. In some embodiments, the more “semantically diverse” the output set 220 generated by the generative model 200, the higher the predictive uncertainty of the generative model 200.

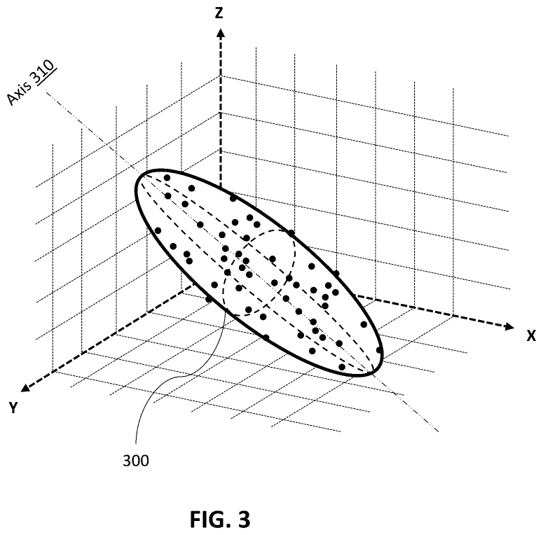

FIG. 3 illustrates a non-isotropic semantic manifold 300, in accordance with various embodiments. The non-isotropic semantic manifold 300 is in a semantic feature space, which is a three-dimension space. The non-isotropic semantic manifold 300 may represent the semantic relationship between generative outputs that are generated by a DNN from an input datum. All the generative outputs may be generated from the same input datum. The generative outputs are shown as black dots in FIG. 3. The non-isotropic semantic manifold 300 encapsulates the generative outputs.

As shown in FIG. 3, the non-isotropic semantic manifold 300 has a larger dimension along an axis 310 than its dimensions along other directions. The axis 310 may be a major semantic axis. The presence of the major semantic axis may indicate a small entropy and t hat that the generative outputs of the DNN are semantically unified. The predictive uncertainty of the DNN is low, meaning the DNN is certain or confident about its response to the input datum.

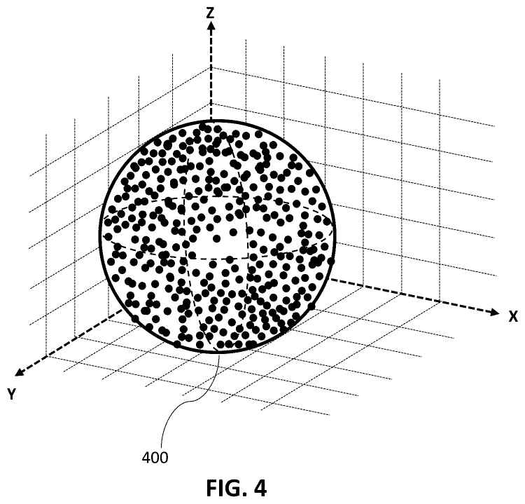

FIG. 4 illustrates an isotropic semantic manifold 400, in accordance with various embodiments. The isotropic semantic manifold 400 is in a semantic feature space, which is a three-dimension space. The isotropic semantic manifold 400 may represent the semantic relationship between generative outputs that are generated by another DNN from an input datum. All the generative outputs may be generated from the same input datum. The generative outputs are shown as black dots in FIG. 4. The isotropic semantic manifold 400 encapsulates the generative outputs.

Different from the non-isotropic semantic manifold 300, the isotropic semantic manifold 400 in FIG. 4 is a sphere (or near sphere) with an isotropic shape. There is no major semantic axis in the isotropic semantic manifold 400. The shape of the isotropic semantic manifold 400 and absence of major semantic axis may indicate that the generative outputs of the DNN are semantically diverse and that the entropy and predictive uncertainty of the DNN are relatively high.

Compared with the DNN in FIG. 3, the DNN in FIG. 4 has higher predictive uncertainty and may be less confident about its response to the input datum. When a generative model is confident in its reply, a small number of differentiated, principal axes may emerge in the semantic feature space, giving rise to a non-isotropic semantic manifold (producing small entropy), whereas the absence of major semantic axes tends to give rise to isotropic manifolds exhibiting large entropy.

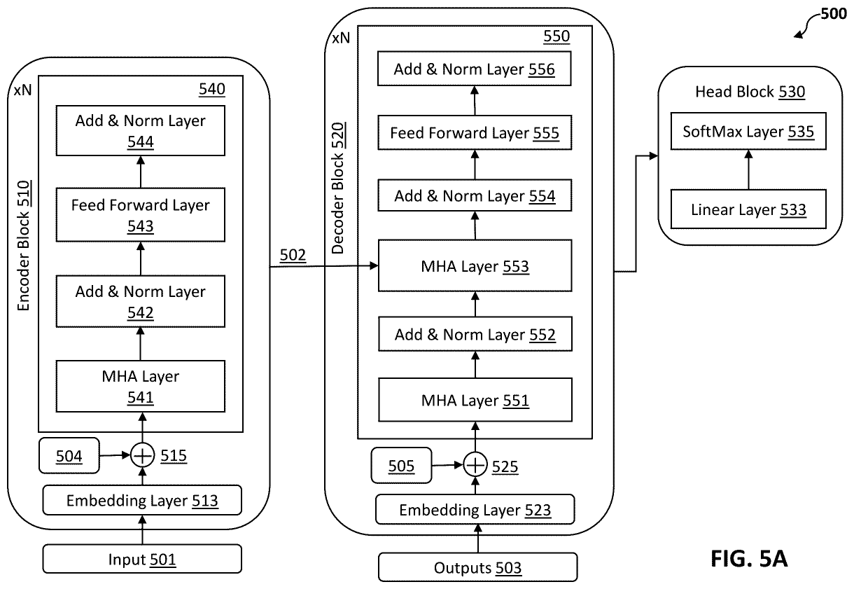

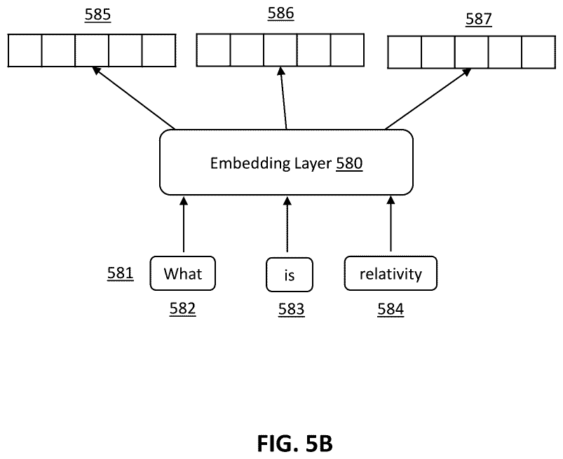

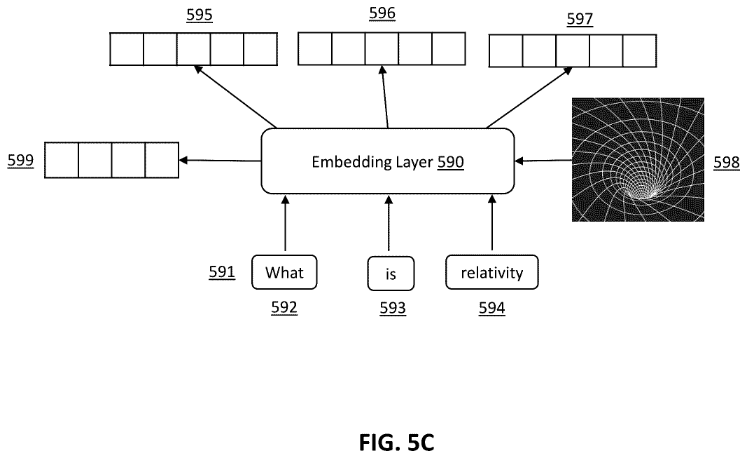

FIG. 5A illustrates an example transformer model 500, in accordance with various embodiments. The transformer model 500 may be at least part of a DNN, which may be an example of the DNNs described above in conjunction with FIGS. 1-4. The transformer model 500 may transform input sequences into output sequences. In some embodiments, the transformer model 500 is a neural network that can learn context and meaning by tracking relationships in sequential data, such as sequential words in a sentence, sequential audio signals, sequential images, and so on. In an example, the transformer model 500 may be an LLM. The transformer model 500 includes an encoder block 510, a decoder block 520, and a head block 530. In other embodiment, different or additional components may be included in the transformer model 500. Further, functionality attributed to a component of the transformer model 500 may be accomplished by a different component included in the transformer model 500 or a different model or module.

The encoder block 510 receives input sequences and generates matrix representations of the input sequences. In the embodiments of FIG. 5A, the encoder block 510 receives inputs 501 and generates encoder outputs 502. In some embodiments, the inputs 501 may include one or more input tokens, such as words, phrases, sentences, images, audio signals, other types of input tokens, or some combination thereof. In an example, the inputs 501 may include a prompt received from a user of the transformer model 500. The prompt may include a question or request made by the user. A word in the prompt may be an input token. The encoder outputs 502 may include one or more vectors that are contextualized representations of the input 501. Each vector in the encoder outputs 502 may represent a token in the input 501 with contextual understanding.

The encoder block 510 includes an embedding layer 513, a positional encoding layer 515, and a plurality of layers 540 (individually referred to as “layer 540”). In other embodiments, the encoder block 510 may have different, fewer, or more components. Also, the arrangement of the components in the encoder block 510 may be different from the arrangement shown in FIG. 5A. For the purpose of illustration, the encoder block 510 has N layers in FIG. 5A, where N is an integer. Each layer 540 may include one or more neural network operations. The layers 540 may transform a sequence of embeddings into a representation that encapsulates the learned information from the input 501. Different layers 540 may have different internal parameters, e.g., different weights, bias, or other types of internal parameters. In some embodiments, the layers 540 have identical components. The components in a layer 540 may be layers and may also be referred to as sub-layers of the layer 540. As shown in FIG. 5A, a layer 540 includes four sub-layers: a multi-head attention (MHA) layer 541, an add & norm layer 542, a feed forward layer 543, and another add & norm layer 544.

The decoder block 520 iteratively generates outputs 503 using encoded representations generated by the encoder block 510. The decoder block 520 includes an embedding layer 523, a positional encoding layer 525, and a plurality of layers 550 (individually referred to as “layer 550”). For the purpose of illustration, the decoder block 520 has N layers in FIG. 5A, where N is an integer. In the embodiments of FIG. 5A, the number of layers 550 in the decoder block 520 is the same as the number of layers 540 in the encoder block 510. In other embodiments, the number of layers 550 in the decoder block 520 may be different from the number of layers 540 in the encoder block 510. Each layer 550 may include one or more neural network operations. Different layers 550 may have different internal parameters. In some embodiments, the layers 550 may have identical components. The components in a layer 550 may be layers and may also be referred to as sub-layers of the layer 550. As shown in FIG. 5A, a layer 550 includes six sub-layers: an MHA layer 551, an add & norm layer 552, an encoder-decoder attention layer 553, another add & norm layer 554, a feed forward layer 555, and another add & norm layer 556.

In some embodiments, a sequence of inference phases is performed in the decoder block 520 using encoder outputs, e.g., the encoder outputs 502. A matrix may be predicted through each inference phase. The outputs 503 may include a plurality of matrices. Each matrix may be further processed in the head block 530 to predict a token. The plurality of matrices may be used to predict a sequence of tokens. For the first inference phase, the decoder block 520 may receive one or more start tokens as input tokens and compute a first matrix from the input tokens and the output of the encoder block 510. The first matrix may be used by the head block 530 to predict a first token. The predicted token may be used as a new input token, in addition to the start token(s), in the second inference phase. Similarly, a second token may be predicted through the second inference phase and may be used in the third inference phase. This iteration may continue till all the inference phases are complete.

The head block 530 receives the output of the decoder block 520 and processes it in a linear layer 533 and a SoftMax layer 535. A linear operation may be performed on the output of the decoder block 520 in the linear layer 533. The linear operation may include a multiplication of the output of the decoder block 520 with a weight matrix. The output of the linear layer 533 may be a vector. In some embodiments, the head block 530 may function as a classifier. The number of data elements in the vector computed in the linear layer 533 may depend on the number of classes involved. In an example where there are M classes, where M is an integer, the vector computed in the linear layer 533 may have M data elements representing the prediction for the M classes, respectively.

The output of the linear layer 533 may be input into the SoftMax layer 535. A SoftMax function may be applied on the output of the linear layer 533 to compute probability scores. A probability score may have a value in the range from 0 to 5. In some embodiments, a probability value is computed for each data element in the vector computed in the linear layer 533. The highest one of the probability scores may be the key. The corresponding index of the key may point to the token that the transformer model 500 predicts as the next in the sequence. The final output of the transformer model 500 may be the sequence of predicted tokens. In some embodiments, the head block 530 may be a language modeling head.

An embedding layer (e.g., the embedding layer 513 or the embedding layer 523) converts an input of the embedding layer (e.g., the inputs 501 or the outputs 503) into one or more embeddings. An embedding may be a vector, which is also referred to as an embedding vector or a vector embedding. The vector embedding may include a sequence of data elements. In some embodiments, the embedding layer 513 may generate a plurality of embeddings, each of which may be converted from a different input token in the inputs 501. The embeddings may capture the semantic meaning of the tokens in the input 501. The embeddings may be numerical representations that capture the relationships or meanings of words, phrases, or other data types. In an example where the input 501 is a prompt including a sequence of words, the embedding layer 513 may generate an embedding from each word in the input 501. The embedding layer 523 in the decoder block 520 may generate a plurality of embeddings from tokens received by the decoder block 520 in a similar manner as the embedding layer 513.

A positional encoding layer (e.g., the positional encoding layer 515 or the positional encoding layer 525) performs positional encoding on embeddings generated in the corresponding embedding layer. In some embodiments, the positional encoding layer may apply one or more positional encoding vectors (e.g., a positional encoding vector 504 or positional encoding vector 505) on vector embeddings from the corresponding embedding layer to generate new vector embeddings that represents the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 541, the MHA layer 551, or the MHA layer 553) may implement a multi-head attention mechanism, which may be a multi-head self-attention mechanism or a multi-head cross-attention mechanism. In some embodiments, the MHA layer 541 or the MHA layer 551 may implement a self-attention mechanism. For self-attention, the queries, keys, and values may come from the same place. For instance, for the MHA layer 541, the queries, keys, and values may all come from the positional encoding layer 515. For the MHA layer 551, the queries, keys, and values may all come from the positional encoding layer 525. The self-attention mechanism may enable the transformer model 500 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 541 may be computed from vector embeddings generated by the positional encoding layer 515. The queries, keys, and values input into the MHA layer 551 may be computed from vector embeddings generated by the positional encoding layer 525. A query, key, or value may be a vector the represents a token in a sequence. In some embodiments, a query matrix Q∈ [symbol] ^{N×h} may be computed by multiply an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiple an embedding matrix X∈ [symbol] ^{N×d} (e.g., an embedding matrix computed in a positional encoding layer) with a weight matrix WₖΣ [symbol] ^{d×h}. Each row in the key matrix may be a key. A value matrix V∈ [symbol] ^{N×h} may be computed by multiple an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 551 may implement masked multi-head self-attention. The MHA layer 551 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 553 may implement a cross-attention mechanism, such as encoder-decoder cross-attention. The MHA layer 553 may use outputs from the previous layer (i.e., the add & norm layer 552) as queries and use outputs from the encoder block 510 as keys and values. The cross-attention can align the encoder's input with the decoder's, empowering the decoder block 520 to identify and emphasize the most relevant parts of the encoder's input.

An add & norm layer in the transformer model 500, such as the add & norm layer 542, 544, 552, 554, and 556, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 542 is the MHA layer 541. As another example, the preceding layer of the add & norm layer 554 is the encoder-decoder attention layer 553.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{x y} = \frac{1}{z} \times {Σ}_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as σ²_{xy}=Σ_{z=1}^{Z}D²_{xyz} and a division computation denoted as

$${M}_{x y} = \frac{1}{\sqrt{\frac{1}{Z} \times ( {{σ}^{2}}_{xy} + ϵ \times Z )}} .$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$${{A}^{′}}_{x y z} = \frac{{A}_{x y z} - {μ}_{x y z}}{\sqrt{\frac{1}{Z} \times ( {{σ}^{2}}_{xy} + ϵ )}} = ( {A}_{x y z} - {μ}_{x y z} ) \times \frac{1}{\sqrt{\frac{1}{Z} \times ( {{σ}^{2}}_{xy} + ϵ )}} = {D}_{x y z} \times {M}_{x y z} .$$

The layer normalization operation may further compute

$${{A}^{″}}_{x y z} = {{A}^{′}}_{x y z} + \frac{{β}_{z}}{{γ}_{z}}$$

and LN_{xyz}=A″_{xyz}×γ_{z}. LN_{xyz} may be the output of the layer normalization operation.

A feed forward layer (e.g., the feed forward layer 543 and the feed forward layer 555) may be a position-wise fully-connected feed forward network. In an example, the feed forward layer may include two linear layers with an activation function in between. An example of the activation function is Rectified Linear Unit (ReLU).

FIG. 5B illustrates an embedding operation in an embedding layer 580, in accordance with various embodiments. The embedding layer 580 may be an example of the embedding layer 513 or the embedding layer 523 in FIG. 5A, e.g., in embodiments where the transformer model 500 is at least part of an LLM. As shown in FIG. 5B, the embedding layer 580 receives an input sequence 581. The input sequence 581 is a textual sequence that includes three words 582, 583, and 584. Each word may be a token. The embedding layer 580 generates a vector embedding 585 from the word 582. The embedding layer 580 also generates a vector embedding 586 from the word 583. The embedding layer 580 further generates a vector embedding 587 from the word 584. In the embodiments of FIG. 5B, the vector embeddings 585, 586, and 587 have the same dimension, i.e., they each have five data elements. In other embodiments, the vector embedding 585, 586, or 587 may have a different dimension. Also, the input sequence 581 may include a different number of words or characters.

In some embodiments where the embedding layer 580 is in an encoder (e.g., the encoder block 510), the input sequence 581 may be an input received by the encoder, such as a prompt made by a user. The input sequence 581 may remain the same during inference of the encoder. In some embodiments where the embedding layer 580 is in a decoder (e.g., the decoder block 520), the input sequence 581 may change and the dimension of the input sequence 581 may be dynamic during inference of the decoder. In an example, the decoder inference may include a sequence of phases. Each inference phase may be conducted for predicting a token. For the first inference phase, the input sequence 581 may include one or more start tokens. For each subsequent inference phase (e.g., the second inference phase, the third inference phase, etc.), the input sequence 581 may include tokens predicted in the previous inference phases. The dimension of the input sequence may be increased by one after each inference phase.

FIG. 5C illustrates an embedding operation in another embedding layer 590, in accordance with various embodiments. The embedding layer 590 may be an example of the embedding layer 513 or the embedding layer 523 in FIG. 5A, e.g., in embodiments where the transformer model 500 is at least part of an LMM. The embedding layer 590 may be a multi-modal embedding layer. As shown in FIG. 5C, the embedding layer 590 receives an input sequence 591 and an input image 598. The input sequence 591 and input image 598 may constitute an input datum.

The input sequence 591 is a textual sequence that includes three words 592, 593, and 594. Each word may be a token. The embedding layer 590 generates a vector embedding 595 from the word 592. The embedding layer 590 also generates a vector embedding 596 from the word 593. The embedding layer 590 further generates a vector embedding 597 from the word 594. In the embodiments of FIG. 5C, the vector embeddings 595, 596, and 597 have the same dimension, i.e., they each have five data elements. In other embodiments, the vector embedding 595, 596, or 597 may have a different dimension.

The embedding layer 590 generates another vector embedding 599 from the image 598. The embedding 599 may be a representation of the 598. In some embodiments, the embedding layer 590 may partition the image 598 into a plurality of portions and may encode each portion with an element in the 599. Even though the embedding 599 in FIG. 5C has four data elements, the embedding 599 may have a different number of data elements in other embodiments. Also, even though not shown in FIG. 5C, the input datum may include one or more other types of data, such as video, audio, and so on.

In some embodiments where the embedding layer 590 is in an encoder (e.g., the encoder block 510), the input datum may be an input received by the encoder, such as a prompt made by a user. The input datum may remain the same during inference of the encoder. In some embodiments where the embedding layer 590 is in a decoder (e.g., the decoder block 520), the input datum may change and the dimension of the input sequence 591 may be dynamic during inference of the decoder. In an example, the decoder inference may include a sequence of phases. Each inference phase may be conducted for predicting a token. For the first inference phase, the input sequence 591 may include one or more start tokens. For each subsequent inference phase (e.g., the second inference phase, the third inference phase, etc.), the input sequence 591 may include tokens predicted in the previous inference phases. The input datum may have more data after each inference phase.

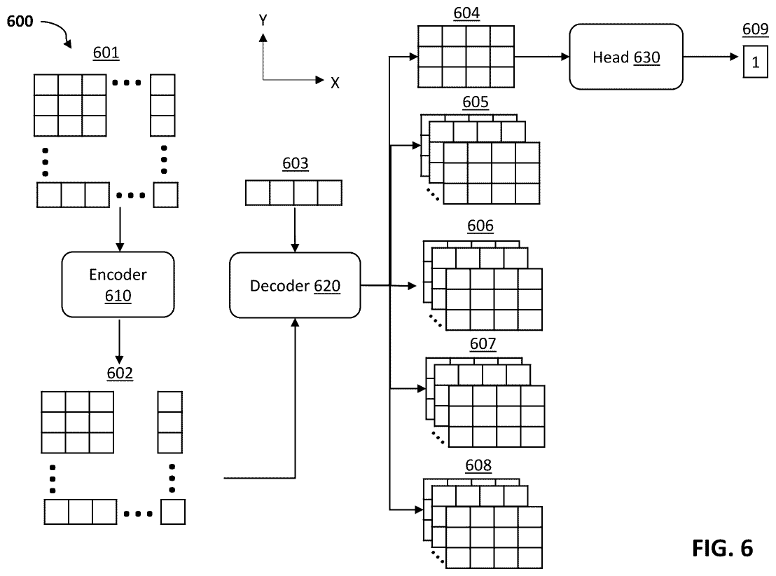

FIG. 6 illustrates a first inference phase of a transformer model 600, in accordance with various embodiments. The transformer model 600 includes an encoder 610, a decoder 620, and a head 630. An example of the transformer model 600 may be the transformer model 500 in FIG. 5A. In the embodiments of FIG. 6, the encoder 610 receives an input tensor 601. The input tensor 601 may be a feature map extracted from one or more images, text documents, audio files, videos, other types of data, or some combination thereof. The encoder 610 generates an output tensor 602 from the input tensor 601. The shape of the output tensor 602 may be denoted as [batch size, SL_{encoder}, d_{model}], where SL_{encoder} may be the dimension along the X axis (i.e., the width of the output tensor 602), and d_{model} may be the dimension along the Y axis (i.e., the height of the output tensor 602). The encoder 610 may include a plurality of layers arranged in a sequence, such as the layers inside the encoder block 510 in FIG. 5A. The output tensor 602 is provided to the decoder 620.

The decoder 620 receives the output tensor 602 and an input sequence 603. The input sequence 603 may be a sequence of tokens. A token may be a numerical representation of an input signal, such as word, image, audio signal, video signal, etc. The dimension of the input sequence 603, which may be denoted as SLᵢₙₚᵤₜ, may be the total number of tokens in the input sequence 603. For the purpose of illustration and simplicity, SLᵢₙₚᵤₜ is 4. In other embodiments, the input sequence 603 may have a different shape. For instance, the input sequence 603 may be a 2D tensor. The dimension of the 2D tensor along the X axis may be SLᵢₙₚᵤₜ, while the dimension of the 2D tensor along the Y axis may be a batch size indicating the number of batches in the input sequence 603.

The decoder 620 computes an output tensor 604, a self-attention key tensor 605, a self-attention value tensor 606, a cross-attention key tensor 607, and a cross-attention value tensor 608. In some embodiments, the shape of the output tensor 604 may be denoted as [batch size, SLᵢₙₚᵤₜ, d_{model}]. The shape of the self-attention key tensor 605 or the shape of the self-attention value tensor 606 may be denoted as N×[batch size, h, SLᵢₙₚᵤₜ, d_{head}], where N is the number of identical layers in the decoder (e.g., the number of layers 550 in the decoder block 520), h is the total number of heads in a MHA layer, and d_{head} is the dimension of a query vector, key vector, or value vector. In some embodiments, d_{model}=h×d_{head}. The shape of the cross-attention key tensor 607 or the shape of the cross-attention value tensor 608 may be denoted as N×[batch size, h, SL_{encoder}, d_{head}].

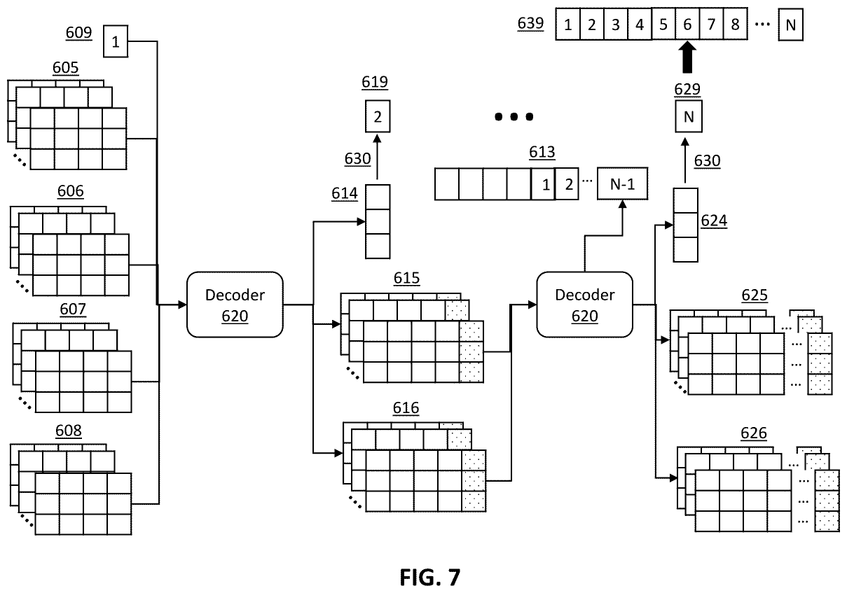

The output tensor 604 may be provided to the head 630 and the head 630 outputs a predicted token 609. The shape of the token 609 may be denoted as [batch size, 1]. For the purpose of illustration and simplicity, batch size is 1 in FIG. 6. In other embodiments, batch size may be a larger number. The predicted token 609 may be stored in a buffer. In some embodiments, the predicted token 609 may be used to update the input sequence 603. For instance, the predicted token 609 may be added to the right of the input sequence 603. The updated input sequence may be used as the input sequence in the second inference phase. In the second inference phase, the decoder 620 may receive the updated input sequence and the output tensor 602 for predicting another token. The output tensor 602 may remain the same during inference of the decoder 620. Certain aspects of subsequent inference phases are described below in conjunction with FIG. 7.

In some embodiments, the self-attention key tensor 605 and the self-attention value tensor 606 may be provided to a self-attention layer in the decoder 620, an example of such a self-attention layer is the MHA layer 151. The self-attention key tensor 605 may be stored in a self-attention key cache. The self-attention key cache may have the same shape as the self-attention key tensor 605. The self-attention value tensor 606 may be stored in a self-attention value cache. The self-attention value cache may have the same shape as the self-attention value tensor 606.

In some embodiments, the decoder 620 computes the self-attention key tensor 605 and the self-attention value tensor 606 from the input sequence 603. The input sequence 603 may be dynamic during inference of the decoder 620. For instance, a new token may be added to the input sequence 603 after each inference phase, as described above. As the input sequence 603 changes, the self-attention key tensor 605 and the self-attention value tensor 606 would also change. For instance, the dimension of the self-attention key tensor 605 or the self-attention value tensor 606 along the X axis may increase as SLᵢₙₚᵤₜ increases. The self-attention key cache and the self-attention value cache may change during all the inference phases of the decoder 620 to accommodate the changes in the self-attention key tensor 605 and the self-attention value tensor 606.

In some embodiments, the cross-attention key tensor 607 and the cross-attention value tensor 606 may be provided to a cross-attention layer in the decoder 620, an example of such a cross-attention layer is the MHA layer 153. The cross-attention key tensor 607 may be stored in a cross-attention key cache. The cross-attention key cache may have the same shape as the cross-attention key tensor 607. The cross-attention value tensor 608 may be stored in a cross-attention value cache. The cross-attention value cache may have the same shape as the cross-attention value tensor 608. In some embodiments, the decoder 620 computes the cross-attention key tensor 607 and the cross-attention value tensor 606 from the output tensor 602 generated in the encoder 610. As the output tensor 602 does not change during inference of the decoder 620, the cross-attention key tensor 607 and the cross-attention value tensor 606 may remain the same during all the inference phases of the decoder 620. The cross-attention key cache and the cross-attention value cache may remain the same during all the inference phases of the decoder 620.

FIG. 7 illustrates subsequent inference phases of the transformer model, in accordance with various embodiments. In the second inference phase, the decoder 620 may reuse the self-attention key tensor 605, self-attention value tensor 606, cross-attention key tensor 607, and cross-attention value tensor 608. The decoder 620 also receives the predicted token 609. The decoder 620 may compute self-attention key vectors from the predicted token 609 and concatenate the self-attention key vectors with the self-attention key tensor 605 to generate a new self-attention key tensor 615. For instance, a self-attention key vector for each head may be added to the right of a self-attention key matrix in the self-attention key tensor 605, and the self-attention key vector and the self-attention key matrix may correspond to the same head. The elements highlighted with a dot pattern in the self-attention key tensor 615 are the self-attention key vectors generated from the predicted token 609.

Similarly, the decoder 620 may compute self-attention value vectors from the predicted token 609 and concatenate the self-attention value vectors with the self-attention value tensor 606 to generate a new self-attention value tensor 616. For instance, a self-attention value vector for each head may be added to the right of a self-attention value matrix in the self-attention value tensor 606, and the self-attention value vector and the self-attention value matrix may correspond to the same head. The elements highlighted with a dot pattern in the self-attention value tensor 616 are the self-attention value vectors generated from the predicted token 609.

The decoder 620 also generates an output tensor 614. The decoder 620 may generate the output tensor 614 using the new self-attention key tensor 615 and new self-attention value tensor 616. The output tensor 614 is used by the head 630 to generate another predicted token 619. The predicted token 619 is the output of the transformer model 600 in the second inference phase.

One or more other subsequent inference phases may be conducted. In each subsequent inference phase, the decoder 620 receives a token predicted in the previous inference phase, a self-attention key tensor generated in the previous inference phase, a self-attention value tensor generated in the previous inference phase, the cross-attention key tensor 607, and the cross-attention value tensor 608. The decoder 620 may, in the subsequent inference phase, generate a larger self-attention key tensor and a larger self-attention value tensor, in addition to an output tensor which can be used by the head 630 to predict a new token.

In embodiments where the total number of inference phases is N, the input sequence 603 is updated to an input sequence 613 after N−1 inference phases. In the last inference phase (i.e., the Nth inference phase), the decoder 620 may receive the predicted token generated in the (N−1)th inference phase, the self-attention key tensor generated in the (N−1)th inference phase, the self-attention value tensor generated in the (N−1)th inference phase, the cross-attention key tensor 607, and the cross-attention value tensor 608. The decoder 620 may generate a self-attention key tensor 625 and a self-attention value tensor 626 using the predicted token generated in the (N−1)th inference phase, the self-attention key tensor generated in the (N−1)th inference phase, and the self-attention value tensor generated in the (N−1)th inference phase. The dimensions of the self-attention key tensor 625 or self-attention value tensor 626 along the X axis is SLᵢₙₚᵤₜ+N. The decoder 620 also generates an output tensor 624, which is used by the head 630 to generate the last predicted token 629. The N tokens predicted by the transformer model in the N inference phases may constitute an output tensor 639, which may be the final output of the transformer model.

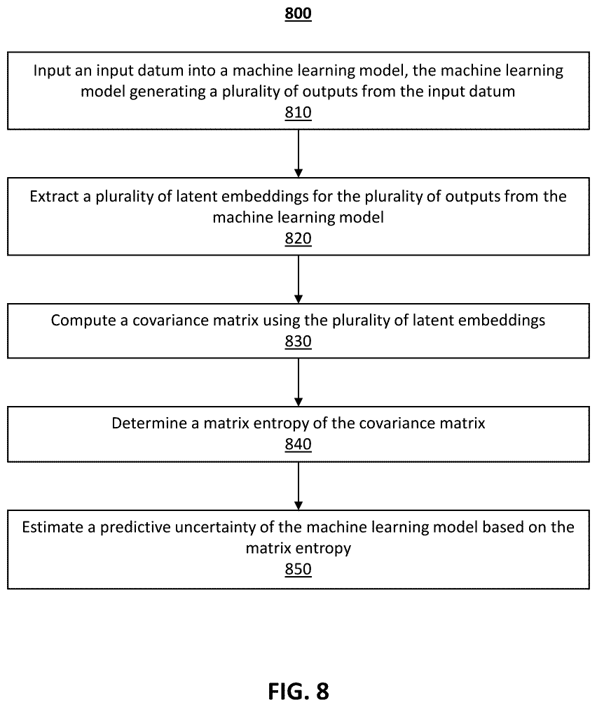

FIG. 8 is a flowchart of a method of uncertainty quantification for a generative model, in accordance with various embodiments. The method 800 may be performed by the uncertainty quantification system 100 in FIG. 1. Although the method 800 is described with reference to the flowchart illustrated in FIG. 8, many other methods of uncertainty quantification for generative models may alternatively be used. For example, the order of execution of the steps in FIG. 8 may be changed. As another example, some of the steps may be changed, eliminated, or combined.

The uncertainty quantification system 100 inputs 810 an input datum into a machine learning model. The machine learning model generates a plurality of outputs from the input datum. In some embodiments, the input datum includes a prompt. In some embodiments, the input datum includes text, image, audio, video, other types of data, or some combination thereof. In some embodiments, the machine learning model is a generative machine learning model.

The uncertainty quantification system 100 extracts 820 a plurality of latent embeddings for the plurality of outputs from the machine learning model. In some embodiments, an output is associated with one or more tokens. A token has a token likelihood indicating a likelihood of the machine learning model selecting a token for the output. A latent embedding is determined based on one or more token likelihoods of the one or more tokens. In some embodiments, the output is associated with a plurality of tokens that has a plurality of token likelihood. The latent embedding is extracted from the output by determining an average of the plurality of token likelihoods.

The uncertainty quantification system 100 computes 830 a covariance matrix using the plurality of latent embeddings. In some embodiments, the uncertainty quantification system 100 centers the plurality of latent embeddings by mean subtracting to produce centered latent embeddings. The uncertainty quantification system 100 computes a length-normalized covariance of the centered latent embeddings. In some embodiments, the covariance matrix has a first dimension and a second dimension, wherein the first dimension is equal to the second dimension.

The uncertainty quantification system 100 determines 840 a matrix entropy of the covariance matrix. In some embodiments, the uncertainty quantification system 100 forms a semantic manifold encapsulating at least part of the plurality of outputs. The uncertainty quantification system 100 determines a dimension of the semantic manifold. The uncertainty quantification system 100 estimates the matrix entropy from the dimension of the semantic manifold.

In some embodiments, the covariance matrix has a plurality of eigenvalues. The uncertainty quantification system 100 ranks the plurality of eigenvalues and selects a subset of eigenvalues from the plurality of eigenvalues based on the ranking. The uncertainty quantification system 100 estimates the matrix entropy using the subset of eigenvalues. In some embodiments, the uncertainty quantification system 100 determines a total number of eigenvalues in the subset of eigenvalues based on one or more attributes of the machine learning model. In some embodiments, the uncertainty quantification system 100 determines a total number of eigenvalues in the subset of eigenvalues based on a total number of outputs in the plurality of outputs.

The uncertainty quantification system 100 estimates 850 a predictive uncertainty of the machine learning model based on the matrix entropy. In some embodiments, the uncertainty quantification system 100 uses the matrix entropy as the predictive uncertainty of the machine learning model.

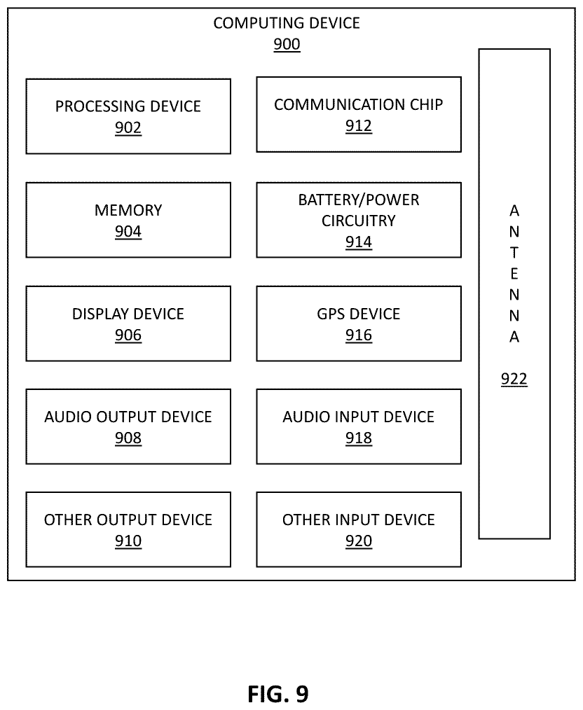

FIG. 9 is a block diagram of an example computing device 900, in accordance with various embodiments. In some embodiments, the computing device 900 can be used as at least part of the uncertainty quantification system 100. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include an audio input device 918 or an audio output device 908 but may include audio input or output device interface circuitry (e.g., connectors and supporting circuitry) to which an audio input device 918 or audio output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable to perform operations for uncertainty quantification for generative models (e.g., the method 800 described in conjunction with FIG. 8) or some operations performed by one or more components of the uncertainty quantification system 100. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include an audio output device 908 (or corresponding interface circuitry, as discussed above). The audio output device 908 may include any device that generates an audible indicator, such as speakers, headsets, or earbuds, for example.

The computing device 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include an audio codec, a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

The following paragraphs provide various examples of the embodiments disclosed herein.

Example 1 provides a method including inputting an input datum into a machine learning model, the machine learning model generating a plurality of outputs from the input datum; extracting a plurality of latent embeddings for the plurality of outputs from the machine learning model; computing a covariance matrix using the plurality of latent embeddings; determining a matrix entropy of the covariance matrix; and estimating a predictive uncertainty of the machine learning model based on the matrix entropy.

Example 2 provides the method of example 1, in which an output is associated with one or more tokens, a token has a token likelihood indicating a likelihood of the machine learning model selecting a token for the output, in which a latent embedding is determined based on one or more token likelihoods of the one or more tokens.

Example 3 provides the method of example 2, in which the output is associated with a plurality of tokens that has a plurality of token likelihoods, in which the latent embedding is extracted from the output by determining an average of the plurality of token likelihoods.

Example 4 provides the method of any one of examples 1-3, in which computing the covariance matrix includes centering the plurality of latent embeddings by mean subtracting to produce centered latent embeddings; and computing a length-normalized covariance of the centered latent embeddings.

Example 5 provides the method of any one of examples 1-4, in which the covariance matrix has a first dimension and a second dimension.

Example 6 provides the method of example 5, in which the first dimension is equal to the second dimension.

Example 7 provides the method of any one of examples 1-6, in which determining the matrix entropy of the covariance matrix including forming a semantic manifold encapsulating at least part of the plurality of outputs; determining a dimension of the semantic manifold; and estimating the matrix entropy from the dimension of the semantic manifold.

Example 8 provides the method of any one of examples 1-6, in which the covariance matrix has a plurality of eigenvalues, in which determining the matrix entropy of the covariance matrix including ranking the plurality of eigenvalues selecting a subset of eigenvalues from the plurality of eigenvalues based on the ranking; and estimating the matrix entropy using the subset of eigenvalues.

Example 9 provides the method of example 8, further including determining a total number of eigenvalues in the subset of eigenvalues based on one or more attributes of the machine learning model.

Example 10 provides the method of example 8 or 9, further including determining a total number of eigenvalues in the subset of eigenvalues based on a total number of outputs in the plurality of outputs.

Example 11 provides one or more non-transitory computer-readable media storing instructions executable to perform operations, the operations including inputting an input datum into a machine learning model, the machine learning model generating a plurality of outputs from the input datum; extracting a plurality of latent embeddings for the plurality of outputs from the machine learning model; computing a covariance matrix using the plurality of latent embeddings; determining a matrix entropy of the covariance matrix; and estimating a predictive uncertainty of the machine learning model based on the matrix entropy.

Example 12 provides the one or more non-transitory computer-readable media of example 11, in which an output is associated with one or more tokens, a token has a token likelihood indicating a likelihood of the machine learning model selecting a token for the output, in which a latent embedding is determined based on one or more token likelihoods of the one or more tokens.

Example 13 provides the one or more non-transitory computer-readable media of example 11 or 12, in which computing the covariance matrix includes centering the plurality of latent embeddings by mean subtracting to produce centered latent embeddings; and computing a length-normalized covariance of the centered latent embeddings.

Example 14 provides the one or more non-transitory computer-readable media of any one of examples 11-13, in which the covariance matrix has a first dimension and a second dimension, and first dimension is equal to the second dimension.

Example 15 provides the one or more non-transitory computer-readable media of any one of examples 11-14, in which determining the matrix entropy of the covariance matrix including forming a semantic manifold encapsulating at least part of the plurality of outputs; determining a dimension of the semantic manifold; and estimating the matrix entropy from the dimension of the semantic manifold.

Example 16 provides the one or more non-transitory computer-readable media of any one of examples 11-15, in which the covariance matrix has a plurality of eigenvalues, in which determining the matrix entropy of the covariance matrix including ranking the plurality of eigenvalues selecting a subset of eigenvalues from the plurality of eigenvalues based on the ranking; and estimating the matrix entropy using the subset of eigenvalues.

Example 17 provides the one or more non-transitory computer-readable media of example 16, in which the operations further include determining a total number of eigenvalues in the subset of eigenvalues based on one or more attributes of the machine learning model or based on a total number of outputs in the plurality of outputs.

Example 18 provides an apparatus including a computer processor for executing computer program instructions; and a non-transitory computer-readable memory storing computer program instructions executable by the computer processor to perform operations including inputting an input datum into a machine learning model, the machine learning model generating a plurality of outputs from the input datum, extracting a plurality of latent embeddings for the plurality of outputs from the machine learning model, computing a covariance matrix using the plurality of latent embeddings, determining a matrix entropy of the covariance matrix, and estimating a predictive uncertainty of the machine learning model based on the matrix entropy.

Example 19 provides the apparatus of example 18, in which an output is associated with one or more tokens, a token has a token likelihood indicating a likelihood of the machine learning model selecting a token for the output, in which a latent embedding is determined based on one or more token likelihoods of the one or more tokens.

Example 20 provides the apparatus of example 18 or 19, in which determining the matrix entropy of the covariance matrix including forming a semantic manifold encapsulating at least part of the plurality of outputs; determining a dimension of the semantic manifold; and estimating the matrix entropy from the dimension of the semantic manifold.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method comprising:
inputting an input datum into a machine learning model, the machine learning model generating a plurality of outputs from the input datum;
extracting a plurality of latent embeddings for the plurality of outputs from the machine learning model;
computing a covariance matrix using the plurality of latent embeddings;
determining a matrix entropy of the covariance matrix; and
estimating a predictive uncertainty of the machine learning model based on the matrix entropy.

2. The method of claim 1, wherein an output is associated with one or more tokens, a token has a token likelihood indicating a likelihood of the machine learning model selecting a token for the output, and a latent embedding is determined based on one or more token likelihoods of the one or more tokens.

3. The method of claim 2, wherein the output is associated with a plurality of tokens that has a plurality of token likelihoods, wherein the latent embedding is extracted from the output by determining an average of the plurality of token likelihoods.

4. The method of claim 1, wherein computing the covariance matrix comprises:
centering the plurality of latent embeddings by mean subtracting to produce centered latent embeddings; and
computing a length-normalized covariance of the centered latent embeddings.

5. The method of claim 1, wherein the covariance matrix has a first dimension and a second dimension.

6. The method of claim 5, wherein the first dimension is equal to the second dimension.

7. The method of claim 1, wherein determining the matrix entropy of the covariance matrix comprising:
forming a semantic manifold encapsulating at least part of the plurality of outputs;
determining a dimension of the semantic manifold; and
estimating the matrix entropy from the dimension of the semantic manifold.

8. The method of claim 1, wherein the covariance matrix has a plurality of eigenvalues, wherein determining the matrix entropy of the covariance matrix comprising:
ranking the plurality of eigenvalues;
selecting a subset of eigenvalues from the plurality of eigenvalues based on the ranking; and
estimating the matrix entropy using the subset of eigenvalues.

9. The method of claim 8, further comprising:
determining a total number of eigenvalues in the subset of eigenvalues based on one or more attributes of the machine learning model.

10. The method of claim 8, further comprising:
determining a total number of eigenvalues in the subset of eigenvalues based on a total number of outputs in the plurality of outputs.

11. One or more non-transitory computer-readable media storing instructions executable to perform operations, the operations comprising:
inputting an input datum into a machine learning model, the machine learning model generating a plurality of outputs from the input datum;
extracting a plurality of latent embeddings for the plurality of outputs from the machine learning model;
computing a covariance matrix using the plurality of latent embeddings;
determining a matrix entropy of the covariance matrix; and
estimating a predictive uncertainty of the machine learning model based on the matrix entropy.

12. The one or more non-transitory computer-readable media of claim 11, wherein an output is associated with one or more tokens, a token has a token likelihood indicating a likelihood of the machine learning model selecting a token for the output, and a latent embedding is determined based on one or more token likelihoods of the one or more tokens.

13. The one or more non-transitory computer-readable media of claim 11, wherein computing the covariance matrix comprises:
centering the plurality of latent embeddings by mean subtracting to produce centered latent embeddings; and
computing a length-normalized covariance of the centered latent embeddings.

14. The one or more non-transitory computer-readable media of claim 11, wherein the covariance matrix has a first dimension and a second dimension, and first dimension is equal to the second dimension.

15. The one or more non-transitory computer-readable media of claim 11, wherein determining the matrix entropy of the covariance matrix comprising:
forming a semantic manifold encapsulating at least part of the plurality of outputs;
determining a dimension of the semantic manifold; and
estimating the matrix entropy from the dimension of the semantic manifold.

16. The one or more non-transitory computer-readable media of claim 11, wherein the covariance matrix has a plurality of eigenvalues, wherein determining the matrix entropy of the covariance matrix comprising:
ranking the plurality of eigenvalues;
selecting a subset of eigenvalues from the plurality of eigenvalues based on the ranking; and
estimating the matrix entropy using the subset of eigenvalues.

17. The one or more non-transitory computer-readable media of claim 16, wherein the operations further comprise:
determining a total number of eigenvalues in the subset of eigenvalues based on one or more attributes of the machine learning model or based on a total number of outputs in the plurality of outputs.

18. An apparatus comprising:
a computer processor for executing computer program instructions; and
a non-transitory computer-readable memory storing computer program instructions executable by the computer processor to perform operations comprising:
inputting an input datum into a machine learning model, the machine learning model generating a plurality of outputs from the input datum,
extracting a plurality of latent embeddings for the plurality of outputs from the machine learning model,
computing a covariance matrix using the plurality of latent embeddings,
determining a matrix entropy of the covariance matrix, and
estimating a predictive uncertainty of the machine learning model based on the matrix entropy.

19. The apparatus of claim 18, wherein an output is associated with one or more tokens, a token has a token likelihood indicating a likelihood of the machine learning model selecting a token for the output, and a latent embedding is determined based on one or more token likelihoods of the one or more tokens.

20. The apparatus of claim 18, wherein determining the matrix entropy of the covariance matrix comprising:
forming a semantic manifold encapsulating at least part of the plurality of outputs;
determining a dimension of the semantic manifold; and
estimating the matrix entropy from the dimension of the semantic manifold.
